(19) United States
(12) Patent Application Publication
(10) Pub. No.: US 2014/0009922 A1
(43) Pub. Date: Jan. 9, 2014

(54) LIGHT-BAR ADHESION FIXTURE AND CORRESPONDING LIGHT-BAR ADHESION METHOD

(71) Applicants: Yanxue Zhang, Guangdong (CN); Yu-Chun Hsiao, Guangdong (CN)

(72) Inventors: Yanxue Zhang, Guangdong (CN); Yu-Chun Hsiao, Guangdong (CN)

(73) Assignee: SHENZHEN CHINA STAR OPTOELECTRONICS TECHNOLOGY CO., LTD., Guangdong (CN)

(21) Appl. No.: 13/636,168

(22) PCT Filed: Jul. 5, 2012
(86) PCT No.: PCT/CN12/78207

§ 371 Date: Sep. 20, 2012

(30) Foreign Application Priority Data
Jul. 4, 2012 (CN) 201210228909.3

(51) Int. Cl. F21V 21/00; B32B 37/12

(52) U.S. Cl. 362/217.14; 156/60

(57) ABSTRACT

The present invention relates to a light-bar adhesion fixture and a corresponding light-bar adhesion method. The light-bar adhesion fixture comprises a base, a position limiting member disposed on a surface of the base and comprising a groove structure for fixing a corresponding heat sink; and a strip-like pad used to cooperate with the groove structure to fix a light emitting diode (LED) light bar on a light-bar fixing portion of the heat sink. The present invention further relates to a light-bar adhesion method. The light-bar adhesion fixture and the corresponding light-bar adhesion method according to the present invention can conveniently achieve a linear adhesion of the LED light bar.

### FIELD OF THE INVENTION

The present invention relates to a field of light source manufacture, and more particularly to a light-bar adhesion fixture and a corresponding light-bar adhesion method.

### BACKGROUND OF THE INVENTION

Existing light emitting diode (LED) backlight modules all use heat sinks to dissipate heat of LED light bars. FIG. 1 is a structural schematic view of a heat sink of an existing LED light bar, wherein the heat sink comprises a light-bar fixing portion 11 and a connecting portion 12, wherein a position limiting structure 121 is disposed on the connecting portion 12. The light-bar fixing portion 11 is used for fixing the LED light bar; and the position limiting structure 121 of the connecting portion 12 is used to limit the position of the fixed light bar, so as to prevent the LED light bar from generating up-down offset.

However, because the position limiting structure 121 of this type of heat sinks has a certain thickness, it is difficult to control the thickness of the position limiting structure 121 when it is made by means of sheet metal punching, so the thickness of the position limiting structure 121 is easy to be uneven. As a result, it is difficult to control the linearity of the light bar when the LED light bar is adhered on the heat sink. In designs of existing light guide plates, a slight bend of an LED light bar is easy to cause a misalignment between the light guide plate and the LED light bar, so as to occur a serious light leak phenomenon.

If using an extrusion molding method to manufacture the above-mentioned position limiting structure 121, it can well control the thickness of the position limiting structure 121, but it needs processing a secondary working, so the manufacture cost of the heat sink is increased.

As a result, it is necessary to provide a light-bar adhesion fixture and a corresponding light-bar adhesion method to solve the problems existing in the conventional technologies.

### SUMMARY OF THE INVENTION

One of the objects of the present invention is to provided with a light-bar adhesion fixture and a corresponding light-bar adhesion method, which can conveniently achieve a linear adhesion of a light emitting diode (LED), so as to solve the existing technological problems that the manufacture cost of the heat sink is higher, or the thickness of the position limiting portion of the light bar is difficult to be controlled causing a light leak.

To solve above-mentioned problem, the present invention is provided with technical solutions, as follows:

The present invention relates to a light-bar adhesion fixture, which comprises: a base; a position limiting member disposed on a surface of the base, and comprising a groove structure for fixing a corresponding heat sink; and a strip-like pad used to cooperate with the groove structure to fix an LED light bar on a light-bar fixing portion of the heat sink; wherein the depth of the groove structure is greater than the thickness of the light-bar fixing portion; and wherein the width of the groove structure is greater than the height of the light-bar fixing portion.

In the light-bar adhesion fixture of the present invention, the height of the LED light bar and the height of the strip-like pad are equal to the height of the light-bar fixing portion.

In the light-bar adhesion fixture of the present invention, the base is provided with a plurality of first fixing holes for fixing the position limiting member.

In the light-bar adhesion fixture of the present invention, the base is provided with a plurality of second fixing holes for fixing the base.

The present invention further relates to a light-bar adhesion fixture, which comprises: a base; a position limiting member disposed on a surface of the base, and comprising a groove structure for fixing a corresponding heat sink; and a strip-like pad used to cooperate with the groove structure to fix an LED light bar on a light-bar fixing portion of the heat sink.

In the light-bar adhesion fixture of the present invention, the depth of the groove structure is greater than the thickness of the light-bar fixing portion.

In the light-bar adhesion fixture of the present invention, the width of the groove structure is greater than the height of the light-bar fixing portion.

In the light-bar adhesion fixture of the present invention, the height of the LED light bar and the height of the strip-like pad are equal to the height of the light-bar fixing portion.

In the light-bar adhesion fixture of the present invention, the base is provided with a plurality of first fixing holes for fixing the position limiting member.

In the light-bar adhesion fixture of the present invention, the base is provided with a plurality of second fixing holes for fixing the base.

The present invention further relates to a light-bar adhesion method, which comprises steps of: (A) preparing a light-bar adhesion fixture, which comprises a fixing member comprising a groove structure for fixing a corresponding heat sink, and a strip-like pad used to cooperate with the groove structure to fix an LED light bar on a light-bar fixing portion of the heat sink; (B) placing a light-bar fixing portion into a groove structure; (C) placing a strip-like pad on one side of the light-bar fixing portion, which is close to a connecting portion of a heat sink; (D) adhering the LED light bar on the other side of the light-bar fixing portion, which is far away from the connecting portion of the heat sink, and fixing the LED light bar by the light-bar fixing portion and the groove structure; and (E) taking the strip-like pad and the heat sink out in turn.

In the light-bar adhesion method of the present invention, the fixing member comprises a base and a position limiting member disposed on a surface of the base; and the step (A) comprises: fixing the position limiting member on the base by first fixing holes, and fixing the base on corresponding setting locations by second fixing holes.

In the light-bar adhesion method of the present invention, the depth of the groove structure is greater than the thickness of the light-bar fixing portion.

In the light-bar adhesion method of the present invention, the width of the groove structure is greater than the height of the light-bar fixing portion.

In the light-bar adhesion method of the present invention, the height of the LED light bar and the height of the strip-like pad are equal to the height of the light-bar fixing portion.

In comparison with an existing light-bar adhesion method, the light-bar adhesion fixture and the corresponding light-bar adhesion method according to the present invention can conveniently achieve a linear adhesion of an LED, so as to solve the existing technological problems that the manufacture cost of the heat sink is higher, or the thickness of the position limiting portion of the light bar is difficult to be controlled causing a light leak.

For above-mention contents of the present invention can be best understood by referring to the following detailed description of the preferred embodiments and the accompanying drawings.

### DESCRIPTION OF THE DRAWINGS

FIG. 1 is a structural schematic view of a heat sink of an existing light emitting diode (LED) light bar;

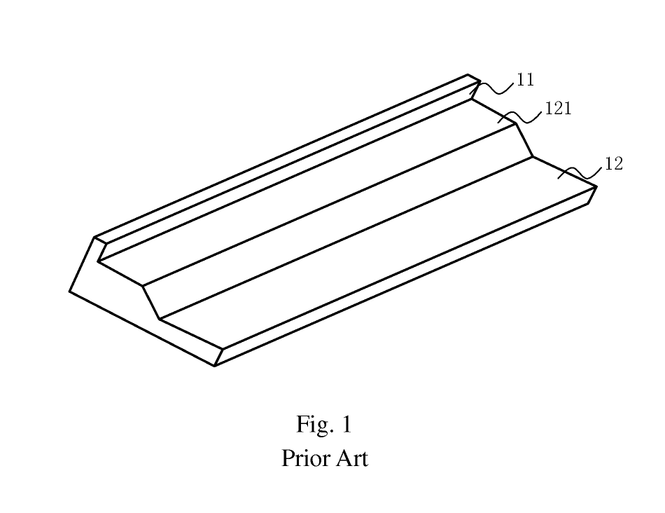

FIG. 2 is an exploded structural schematic view of a light-bar adhesion fixture of a preferred embodiment according to the present invention;

FIG. 3 is an operational schematic view of the light-bar adhesion fixture of the preferred embodiment according to the present invention;

FIG. 4 is a cross-sectional schematic view of the light-bar adhesion fixture of the preferred embodiment according to the present invention;

FIG. 5 is an enlarged view of an “A part” in the FIG. 4; and

FIG. 6 is a flow chart of a light-bar adhesion method of the preferred embodiment according to the present invention.

### DETAILED DESCRIPTION OF THE PREFERRED EMBODIMENTS

The description of the preferred embodiments refers to the drawings, so as to illustrate the specific embodiments of the present invention which can be carried out. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, the units with the similar structure use the same numerals.

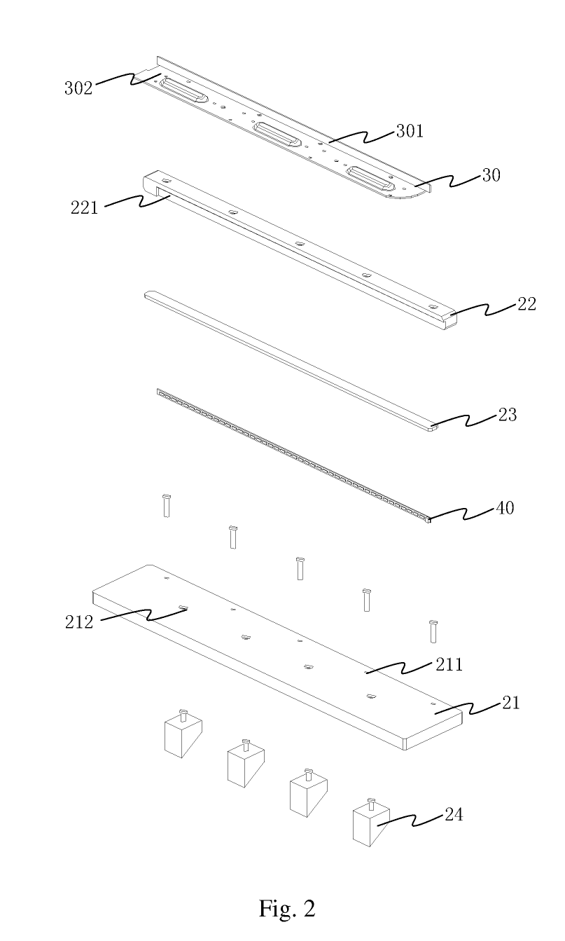

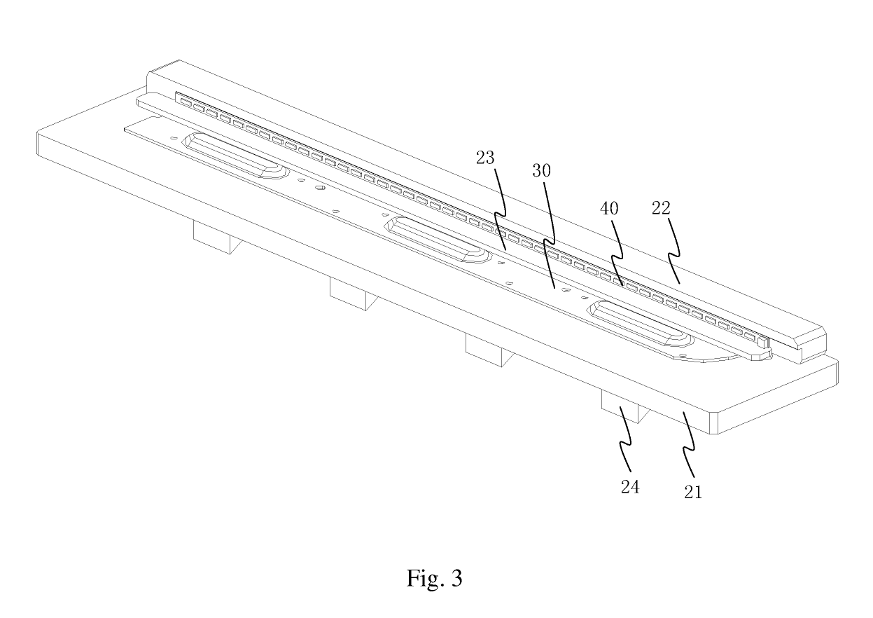

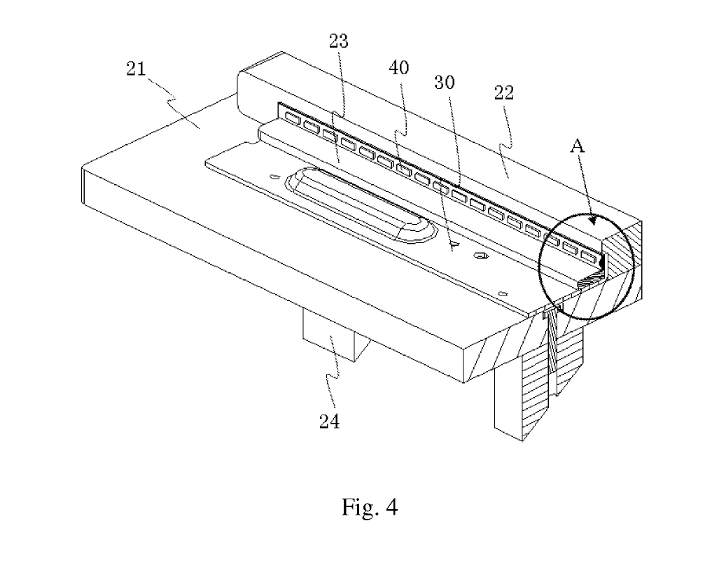

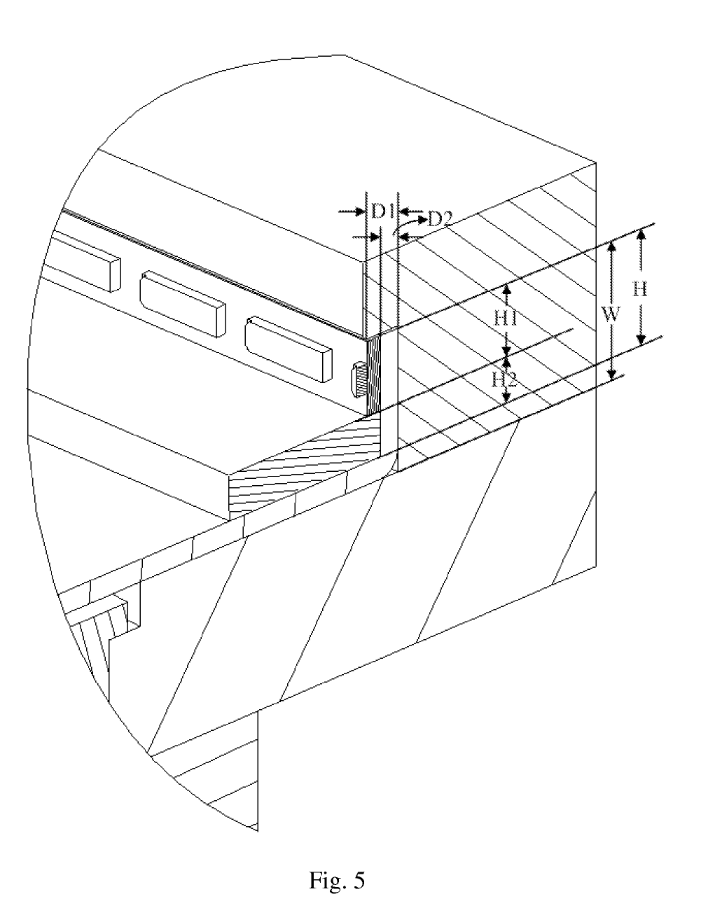

Referring now to FIGS. 2 to 5, an exploded structural schematic view of a light-bar adhesion fixture of a preferred embodiment according to the present invention is illustrated in FIG. 2; an operational schematic view of the light-bar adhesion fixture of the preferred embodiment according to the present invention is illustrated in FIG. 3; a cross-sectional schematic view of the light-bar adhesion fixture of the preferred embodiment according to the present invention is illustrated in FIG. 4; and an enlarged view of an “A part” in the FIG. 4 is illustrated in FIG. 5. The light-bar adhesion fixture comprises a base 21, a position limiting member 22 and a strip-like pad 23, wherein the base 21 and the position limiting member 22 jointly construct as a fixing member of the light-bar adhesion fixture. The position limiting member 22 is disposed on a surface of the base 21, which has a groove structure 221 for fixing a corresponding heat sink 30; and the strip-like pad 23 is used to cooperate with the groove structure 221 to fix a light emitting diode (LED) light bar 40 on a light-bar fixing portion 301 of the heat sink 30. The depth D1 of the groove structure 221 is greater than the thickness D2 of the light-bar fixing portion 301; the width W of the groove structure 221 is greater than the height H of the light-bar fixing portion 301; and the height H1 of the LED light bar 40 and the height H2 of the strip-like pad 23 are equal to the height H of the light-bar fixing portion 301. The base 21 is provided with a plurality of first fixing holes 211 and second fixing holes 212, wherein the position limiting member 22 can be fixed and connected with the base 21 by first fixing holes 211, and the base 21 can be fixed and connected with corresponding setting locations 24 by second fixing holes 212.

The operation of the light-bar adhesion fixture according to the present invention mainly comprises two processes.

A first process is an assembly process: assembling the light-bar adhesion fixture, it is to connect the position limiting member 22 and the base 21 by first fixing holes 211, and to fix the base 21 by second fixing holes 212, so the base and the position limiting member is formed as the fixing member of the light-bar adhesion fixture.

A second process is an adhesion process: place the corresponding light-bar fixing portion 301 of the heat sink 30 into the groove structure 221 of the position limiting member 22 (the width W of the groove structure 221 is a little greater than the height H of the light-bar fixing portion 301). Because the depth D1 of the groove structure 221 is greater than the thickness D2 of the light-bar fixing portion 301, the groove structure 221 can protrude out the surface of the light-bar fixing portion 301. Then, place the strip-like pad 23 against the protruding portion of the groove structure 221 to adjoin one side of the light-bar fixing portion 301, which is close to a connecting portion 302 of the heat sink 30; place the LED light bar 40 against the protruding portion of the groove structure 221 to be adhered on the other side of the light-bar fixing portion 301, which is far away from the connecting portion 302 of the heat sink 30 (the height H1 of the LED light bar 40 and the height H2 of the strip-like pad 23 are equal to the height H of the light-bar fixing portion 301). In this way, the LED light bar 40 can be fixed on the light-bar fixing portion 301 of the heat sink 30 by the strip-like pad 23 and the groove structure 221. Because the LED light bar 40 is against the groove structure 221 and the strip-like pad 23 to be fixed, it can ensure the linearity when fixing the LED light bar 40. After the LED light bar 40 is adhered on the light-bar fixing portion 301, the strip-like pad 23 and the heat sink 30 adhered with the LED light bar 40 can be take out in turn, so that it is finished the adhesion of the LED light bar 40.

It is necessary to do the above-mentioned adhesion process every time the LED light bar 40 is adhered. However, the assembly process is only to be done at the first time to use the light-bar adhesion fixture, so it is not necessary to do the assembly process every time the LED light bar 40 is adhered.

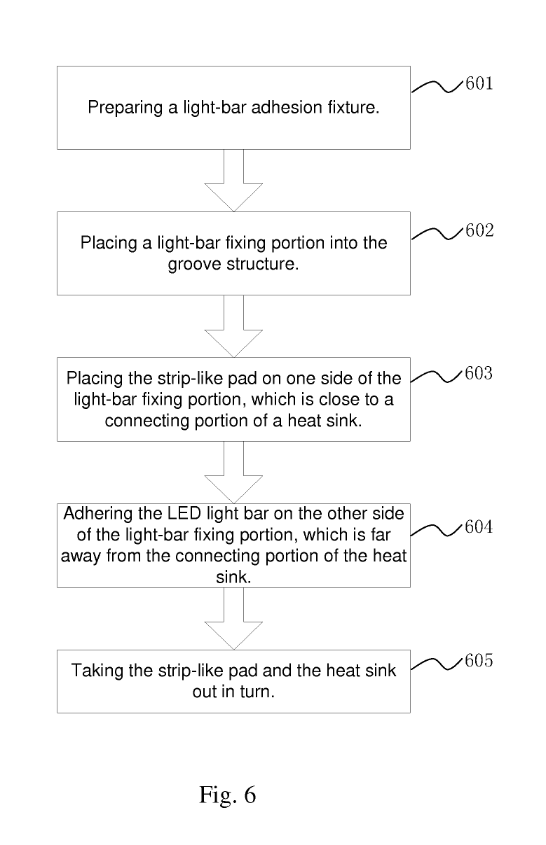

The present invention further relates to a light-bar adhesion method. Referring now to FIG. 6, a flow chart of a light-bar adhesion method of the preferred embodiment according to the present invention is illustrated in FIG. 6. The light-bar adhesion method comprises:

Step 601: preparing a light-bar adhesion fixture;

Step 602: placing a light-bar fixing portion into a groove structure;

Step 603: placing a strip-like pad on one side of the light-bar fixing portion, which is close to a connecting portion of a heat sink;

Step 604: adhering the LED light bar on the other side of the light bar fixing portion, which is far away from the connecting portion of the heat sink, and fixing the LED light bar by the strip-like pad and the groove structure; and

Step 605: taking the strip-like pad and the heat sink out in turn.

The light-bar adhesion fixture comprises a fixing member and a strip-like pad, wherein the fixing member comprises a base and a position limiting member disposed on a surface of the base. The position limiting member is disposed on the surface of the base, and has a groove structure for fixing a corresponding heat sink; the strip-like pad is used to cooperate with the groove structure to fix an LED light bar on a light-bar fixing portion of a heat sink; and the base is further provided with a plurality of first fixing holes and second fixing holes.

In the step 601, preparing a light-bar adhesion fixture, it is specifically as: the position limiting member is fixed on the base by first fixing holes, and the base is fixed on corresponding setting locations by second fixing holes. Now, the position limiting member and the base both are fixed and immovable, so as to form as the fixing member of the light-bar adhesion fixture. After this step to assemble for once, when next time to adhere the LED light bar, it is not necessary to process the assembly again, and just use them directly.

In the step 602, placing a light-bar fixing portion into a groove structure. In this step, the width of the groove structure is a little greater than the height of the light-bar fixing portion, and because the depth of the groove structure is greater than the thickness of the light-bar fixing portion, so that the groove structure can protrude out the surface of the light-bar fixing portion.

In the step 603, placing a strip-like pad on one side of the light-bar fixing portion, which is close to a connecting portion of a heat sink, it is specifically as:

the strip-like pad is against the protruding portion of the groove structure, and adjoins one side of the light-bar fixing portion, which is close to a connecting portion of a heat sink.

In the step 604, adhering the LED light bar on the other side of the light-bar fixing portion, which is far away from the connecting portion of the heat sink, it is specifically as: the LED light bar is against the protruding portion of the groove structure, and is adhered on the other side of the light-bar fixing portion, which is far away from the connecting portion of the heat sink. The length direction of the adhered LED light is approximately parallel with the length direction of the light-bar fixing portion. Because the height of the LED light bar and the height of the strip-like pad are equal to the height of the light-bar fixing portion, the LED light pressed and adhered with the strip-like pad can keep the adhered LED light bar a better linearity, so that the LED light bar is fixed on the light-bar fixing portion of the heat sink by the strip-like pad and the groove structure.

In the step 605, taking the strip-like pad and the heat sink out in turn, so as to finish the adhesion of the LED light bar.

The light-bar adhesion fixture and the corresponding light-bar adhesion method according to the present invention can conveniently achieve a linear adhesion of the LED light bar. Meanwhile, it is not necessary to dispose a special position limiting structure on the connecting portion of the heat sink, so the heat sink can be manufactured by a method of sheet metal punching, so as to decrease the manufacture cost of the heat sink. It can well to solve the existing technological problems that the manufacture cost of the heat sink is higher, or the thickness of the position limiting portion of the light bar is difficult to be controlled causing a light leak.

As described above, the present invention has been described with a preferred embodiment thereof and it is understood that many changes and modifications to the described embodiment can be carried out without departing from the scope and the spirit of the invention that is intended to be limited only by the appended claims.

1. A light-bar adhesion fixture, comprising:
a base;
a position limiting member disposed on a surface of the base, and comprising: a groove structure for fixing a corresponding heat sink; and
a strip-like pad cooperated with the groove structure to fix a light emitting diode (LED) light bar on a light-bar fixing portion of the heat sink;
wherein the depth of the groove structure is greater than the thickness of the light-bar fixing portion; and
wherein the width of the groove structure is greater than the height of the light-bar fixing portion.

2. The light-bar adhesion fixture according to claim 1, wherein the height of the LED light bar and the height of the strip-like pad are equal to the height of the light-bar fixing portion.

3. The light-bar adhesion fixture according to claim 1, wherein the base is provided with a plurality of first fixing holes for fixing the position limiting member.

4. The light-bar adhesion fixture according to claim 1, wherein the base is provided with a plurality of second fixing holes for fixing the base.

5. A light-bar adhesion fixture, comprising:
a base;
a position limiting member disposed on a surface of the base, and comprising a groove structure for fixing a corresponding heat sink; and
a strip-like pad cooperated with the groove structure to fix an LED light bar on a light-bar fixing portion of the heat sink.

6. The light-bar adhesion fixture according to claim 5, wherein the depth of the groove structure is greater than the thickness of the light-bar fixing portion.

7. The light-bar adhesion fixture according to claim 5, wherein the width of the groove structure is greater than the height of the light-bar fixing portion.

8. The light-bar adhesion fixture according to claim 5, wherein the height of the LED light bar and the height of the strip-like pad are equal to the height of the light-bar fixing portion.

9. The light-bar adhesion fixture according to claim 5, wherein the base is provided with a plurality of first fixing holes for fixing the position limiting member.

10. The light-bar adhesion fixture according to claim 5, wherein the base is provided with a plurality of second fixing holes for fixing the base.

11. A light-bar adhesion method, comprising steps of:
(A) preparing a light-bar adhesion fixture which comprises:
a fixing member comprising a groove structure for fixing a corresponding heat sink; and
a strip-like pad cooperated with the groove structure to fix an LED light bar on a light-bar fixing portion of the heat sink;
(B) placing a light-bar fixing portion into the groove structure;
(C) placing the strip-like pad on one side of the light-bar fixing portion, which is close to a connecting portion of a heat sink;
(D) adhering the LED light bar on the other side of the light-bar fixing portion, which is far away from the connecting portion of the heat sink, and fixing the LED light bar by the light-bar fixing portion and the groove structure; and
(E) taking the strip-like pad and the heat sink out in turn.

12. The light-bar adhesion method according to claim 11, wherein the fixing member comprises a base and a position limiting member disposed on a surface of the base; and the step (A) comprises: fixing the position limiting member on the base by first fixing holes, and fixing the base on corresponding setting locations by second fixing holes.

13. The light-bar adhesion method according to claim 11, wherein the depth of the groove structure is greater than the thickness of the light-bar fixing portion.

14. The light-bar adhesion method according to claim 11, wherein the width of the groove structure is greater than the height of the light-bar fixing portion.

15. The light-bar adhesion method according to claim 11, wherein the height of the LED light bar and the height of the strip-like pad are equal to the height of the light-bar fixing portion.
